(19) United States
(12) Patent Application Publication
(10) Pub. No.: US 2026/0245363 A1
(43) Pub. Date: Aug. 20, 2026

(54) HYPERSPECTRAL IMAGING METHOD AND SYSTEM USING A FLOCK OF SENSORS

(71) Applicants: THE STATE OF ISRAEL, MINISTRY OF AGRICULTURE & RURAL DEVELOPMENT, AGRICULTURAL RESEARCH, Rishon Lezion (IL); RAMOT AT TEL AVIV UNIVERSITY LTD., Tel Aviv (IL)

(72) Inventors: Iftach KLAPP, Rishon Lezion (IL); Nir SOCHEN, Tel Aviv (IL); Liad RESHEF, Kfar Saba (IL); Navot OZ, Rishon Lezion (IL); Omri BERMAN, Rishon Lezion (IL); Eitan GOLDSTEIN, Rishon Lezion (IL); David MENDLOVIC, Tel Aviv (IL); Liron ZILBERBERG, Kfar Saba (IL)

(21) Appl. No.: 19/159,338

(22) PCT Filed: Feb. 23, 2024
(86) PCT No.: PCT/IB2024/051749

§ 371 Date: Aug. 25, 2025

Related U.S. Application Data
(60) Provisional application No. 63/447,682, filed on Feb. 23, 2023.

(51) Int. Cl. G06V 20/10; G06T 3/4053; G06T 7/33; G06T 7/80; H04N 23/11

(52) U.S. Cl. CPC G06V 20/194; G06T 3/4053; G06T 7/33; G06T 7/80; H04N 23/11; G06T 2207/10036; G06T 2207/20084

(57) ABSTRACT

A method and system for hyperspectral imaging uses a flock of at least two sensors which provide images of an overlapped region-of-interest in at least two different spectral bands. The latter may include a visual band and one or more infrared bands. Using a variety of calibration, registration, super-resolution, and data fusion algorithms, a signal processor corrects and analyzes the images to form a hyperspectral image cube with high spatial resolution. The signal processor typically is in communication with or integrated with a tracking station, and it may be spaceborne, airborne, shipborne, or ground-based. An exemplary neural network is provided for implementation of the method for hyperspectral imaging.

### CROSS-REFERENCE TO RELATED APPLICATIONS

This application is related to and claims priority from commonly owned U.S. Provisional Patent Application No. 63/447,682, entitled “Hyperspectral Imaging Method and System using a Flock of Small Satellites”, filed on Feb. 23, 2023, the disclosure of which is incorporated by reference in its entirety herein.

### TECHNICAL FIELD

The present invention relates to remote sensing, and in particular, to methods and systems for forming hyperspectral images using a flock of sensors.

### BACKGROUND OF THE INVENTION

Satellites for use in multispectral (MS) remote sensing span a variety of sizes and form factors. For example, Landsat 8, launched in 2013, has a mass of 1512 kg. and carries MS sensors ranging from the visible (VIS) band through near-infrared (NIR), short wave infrared (SWIR), and long wave infrared (LWIR) radiation bands. The spatial resolution of the LWIR, or thermal infrared, band is 30 to 100 meters (m.). Sentinel 2, launched in 2015, has a mass of 100 kilograms (kg.) and is equipped with MS sensors covering 13 radiation bands between VIS and SWIR. The Vegetation and Environment monitoring on a New Micro Satellite (VENUS), launched in August 2017, has a mass of 268 kg. and is equipped with 12 bands from VIS to NIR, with a spatial resolution of 5.3 meters in the NIR band.

G. Konecny, in a paper entitled “Small satellites—A tool for Earth observation?”, appearing in XXth ISPRS Congress, Commission, vol. 4, July 2004, pp. 12-23, classifies small satellites with a mass between 10 and 100 kg. as micro-satellites, and those with a mass between 1 and 10 kg. as nano-satellites. Another commonly used classification is based on volume: a standard CubeSat having a “1U” form factor measures 10×10×11.35 centimeter (cm.), and provides 1000 cubic cm. of useful volume. Many nano-satellites that are currently in orbit are CubeSats with a 3U form factor.

Satellite imagery for use in precision agriculture typically utilizes an MS sensor that typically provides images in a visible (VIS) band, a near infrared (NIR) band, e.g. in the wavelength range from 0.72 to 1.0 microns, a long-wave infrared (LWIR) band, e.g. in the wavelength range from 8 to 12 microns, and possibly other radiation bands as well. The LWIR band is especially important as it includes thermal radiation emitted by vegetation, which is important for example in detecting water stress in agricultural plants.

An MS sensor generally incorporates many different optical detectors, each optimized for a specific slice of optical wavelengths and/or polarizations and each characterized by a different set of performance parameters, such as spatial resolution, image acquisition time, signal-to-noise ratio (SNR), and frame rate. Current detectors for the LWIR band range from expensive forward-looking infrared (FLIR) systems to relatively inexpensive uncooled micro-bolometer focal plane arrays (FPAs).

A micro-bolometer FPA typically is characterized by 12 micron to 17 micron pixels, which results in a native instantaneous field of view (iFOV) on the order of 0.2 milliradians (mrad.) and a ground sampling distance (GSD) of about 80 m. at an orbital altitude of 400 km. This is an order of magnitude coarser than the spatial resolution achieved in the VIS range with standard CMOS cameras.

The images provided by different detectors in different spectral bands may be “fused”. When the images are provided by a system composed of many different sensors covering multiple spectral bands, the fused image data is said to form a hyperspectral image, or “HS image cube”. The fusion, which may be implemented in a signal or image processor, requires a variety of algorithms to compensate for differences between the spectral bands with regard to pixel size, field of view (FOV), illumination intensity, line-of-sight direction, SNR, and a host of other factors. As an example, International Publication no. WO 2021/048863A1 to N. Oz et al., published on Mar. 18, 2021, and entitled “Methods and Systems for Super Resolution for Infra-Red Imagery” (hereinafter referred to as WO'863), discloses an artificial neural network for processing low-resolution infrared (IR) images in order to form an HS image having super-resolution.

As pointed out in the abovementioned paper by Konecny, the use of small satellites, in place of those weighing more than 10 kg, can greatly reduce the costs of satellite construction and launching in remote-sensing applications. Recently, 39 nano-satellite projects have been report, of which eight involved multiple nano satellites, with form factors of 1U to 3U, placed at heights of between 400 and 800 km. above the Earth. The latter projects include those shown in Table 1.

TABLE 1
Some Nano-satellite Remote-sensing Projects

| Project Name | Remote-sensing application |
|---|---|
| DICE | Monitoring in-situ plasma |
| FIREBIRD | Measuring electromagnetic bursts |
| Flock-1 | High resolution earth imaging |
| EDSN | Emission monitoring |
| QB50 | Lower thermosphere (90-350 km) measurements |
| GGC | Weather mission for ionospheric remote sensing |
| Charybdis | High spatial and temporal resolution of coastal |
| | and inland waterways for sediment, water |
| | dynamics, and ocean tidal color studies |

For example, in a single launch of the Flock-1 project, Plant Lab placed a group of 88 “Dove” type nano-satellites in orbit. Each satellite weighed about 5 kg., and the number of satellites in the group was later increased to 170. This group covers two million km² per day with 3-5 meter spatial resolution from an altitude of 420 km. The spectral range includes 4 VIS bands and an NIR band.

As another example, the Charybdis project includes a group of 145 nano-satellites, 30 of which cover the UK mainland while the remainder are used for global surveillance of the seas. In order to study the tidal variation of biological distributions near the sea coast, a tidal-synchronous orbital path (rather than a Sun-synchronous orbital path) is used, and each point on the path is sampled by one the nano-satellites every two hours. Spatial imaging with a resolution of 30 meters is provided over 7 spectral bands in the VIS to NIR range.

### SUMMARY OF THE INVENTION

In the context of this specification, the term “small satellite” denotes a satellite which has a mass in the range of 1 to 10 kg. and a form factor which is less than or equal to 12 U. The term “VIS band” refers to the wavelength range from 0.4 to 0.72 microns, and the term “LWIR band” refers to the wavelength range from 8 to 12 microns.

The invention is directed to forming an HS image cube with high spatial resolution by combining images in different spectral ranges provided by a flock of sensors. According to one aspect of the presently disclosed subject matter, there is provided a system for hyperspectral imaging including a flock of at least two sensors configured to provide image frame sequences in at least two different spectral bands; a signal processor configured for receiving, correcting and analyzing the image frame sequences to form a hyperspectral (HS) image cube with high spatial resolution; and an output device for recording and/or displaying the HS image cube. The sensors pass above an overlapped region-of-interest (ROI).

According to some aspects, at least one of the sensors includes an imaging device selected from a group consisting of a monochromatic camera, a color camera, a thermal camera, an infrared camera, a panchromatic camera, and a bolometer focal plane array.

According to some aspects, at least one of the sensors includes a camera controller, a mechanical support, a spectral bandpass filter, a video card, an accelerometer, and/or an inertial measurement unit.

According to some aspects, the different spectral bands include a band selected from a group consisting of a visual band, a near-infrared band, a short-wave infrared band, and a long-wave infrared band.

According to some aspects, at least two of the sensors are characterized by different pixel sizes, spatial resolutions, polarizations, integration times, frame times, signal-to-noise ratios, and/or point spread functions.

According to some aspects, correcting and analyzing the image frame sequences includes a calibration algorithm which further includes corrections of white balance, gain, offset, illumination, and/or optical aberrations.

According to some aspects, correcting and analyzing the image frame sequences includes a registration algorithm which further includes temporal alignment, spatial alignment, projective transformation estimation, feature detection, and/or simultaneous localization and mapping.

According to some aspects, correcting and analyzing the image frame sequences includes a super-resolution algorithm which further includes an absolute value cost function, a perceptual loss function, and/or a sum of cost and loss functions.

According to some aspects, the signal processor is in communication with or integrated with a tracking station.

According to some aspects, at least two of the sensors are mounted on different platforms.

According to some aspects, at least one of the platforms is a small satellite having a mass in a range of 1 to 10 kilograms.

According to another aspect of the presently disclosed subject matter, there is provided a method for hyperspectral imaging which includes the following steps: receiving data from a flock of at least two sensors configured to provide image frame sequences in at least two different spectral bands; applying a calibration algorithm to the image frame sequences; applying a registration algorithm to the image frame sequences; and applying one or more image enhancement algorithms to form an HS image cube with high spatial resolution. The at least two sensors pass above an overlapped region-of-interest.

According to some aspects, the method includes an addition step of storing and/or displaying the HS image cube in an output device.

According to some aspects, the at least two different spectral bands comprise at least one visual band and one or more infrared bands.

According to some aspects, the calibration algorithm includes correction of white balance, gain, offset, illumination, and/or optical aberrations.

According to some aspects, the registration algorithm comprises temporal alignment, spatial alignment, projective transformation estimation, feature detection, and/or simultaneous localization and mapping.

According to some aspects, the one or more image enhancement algorithms include a data fusion algorithm and/or a super-resolution algorithm.

According to some aspects, the super-resolution algorithm includes an absolute value cost function, a perceptual loss function, and/or a sum of cost and loss functions.

According to some aspects, the method is implemented by a neural network.

According to some aspects, the neural network receives as input a high-resolution visual image and a low-resolution infrared image.

According to some aspects, the neural network comprises at least one module selected from a group consisting of a Visible Feature Framer (VFF) module, a Spatial Transformer Network (STN) module, and a Process-Upscale-and-Fuse (PUF) module.

According to some aspects, there is provided a computer usable non-transitory storage medium having a computer program for executing the steps of the method in a signal processor.

### BRIEF DESCRIPTION OF THE DRAWINGS

Some embodiments of the present invention are herein described, by way of example only, with reference to the accompanying drawings. With regard to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1: A diagram of an exemplary system for forming HS images using a flock of sensors, according to the invention.

FIG. 2A: An exemplary first embodiment of a small-satellite sensor.

FIG. 2B: An exemplary second embodiment of a small-satellite sensor.

FIG. 3: A block diagram of an exemplary method for forming HS images with high spatial resolution, according to the invention.

FIG. 4: A block diagram of an exemplary neural network for implementing the method of the invention.

FIGS. 5A-5C: Block diagrams of three modules in the neural network of FIG. 4.

FIGS. 6A-6D: Results of HS imaging algorithms applied to a first set of experimentally recorded images.

FIGS. 7A-7F: Results of HS imaging algorithms applied to a second set of experimentally recorded images.

FIGS. 8A-8C: Results of HS imaging algorithms applied to a third set of experimentally recorded images.

### DETAILED DESCRIPTION OF THE INVENTION

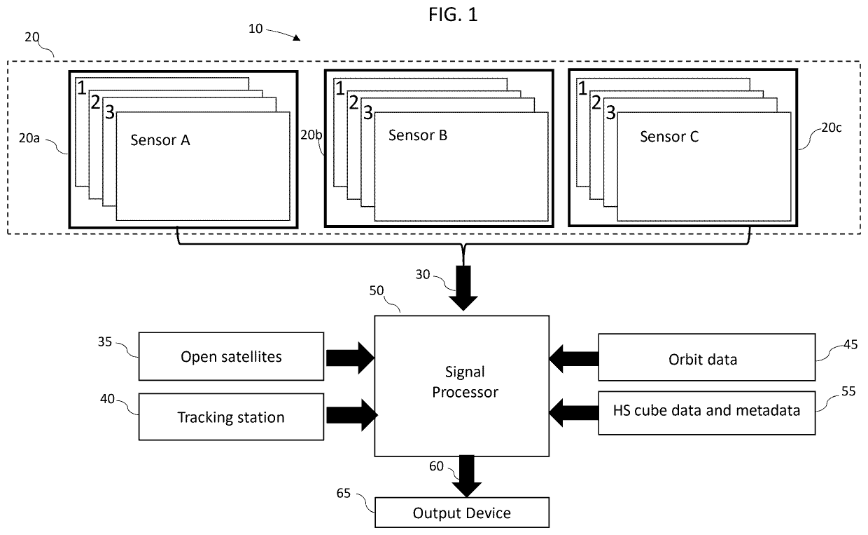

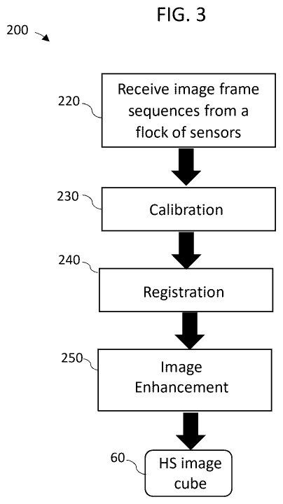

FIG. 1 shows a diagram of an exemplary system 10 for forming HS images using a flock of sensors 20, according to the invention. The flock includes, for example, sensor A, B, and C, labelled 20a, 20b and 20c, respectively. Each sensor typically is mounted on a separate platform and provides a sequence of images, labelled 1, 2, and 3, covering a specific spectral range consisting of, for example, one or more LWIR bands, or alternatively a mixture of bands belonging to different radiation wavelengths. The image frame sequences 30 may be transmitted via a communication link to a signal processor 50, which may be spaceborne, airborne, shipborne, or ground-based. The signal processor 50 typically is in communication with or integrated with a tracking station 40. Using specialized algorithms, the signal processor corrects and analyzes the image frame sequences and generates a fused HS image cube 60 with high spatial resolution. HS image cube 60 is sent to an output device 65 for recording and/or display. Device 65 may be for example a video recorder, a computer monitor, or a volatile or non-volatile computer memory. Further details of the specialized algorithms used by signal processor 50 are given in FIG. 3 and its associated description.

In some embodiments, signal processor 50 may receive additional data, such as data from open satellites 35 (not belonging to flock 20), orbit data 45, and HS cube data and metadata 55. The nature and format of this additional data is familiar to those skilled in the art of remote sensing.

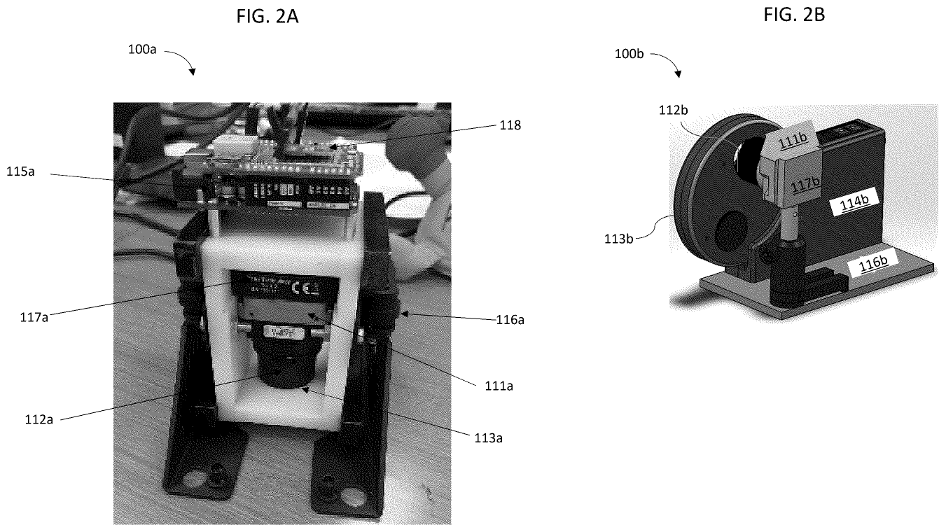

FIG. 2A shows an exemplary first embodiment of a small-satellite sensor 100a, which is suitable for a satellite with a 1U form factor. The sensor 100a includes an uncooled micro-bolometer FPA thermal camera 111a with a pixel size of, for example, 17 microns. Lens 112a has an exemplary focal length of 100 mm. and the pixel field of view is approximately 0.17 milliradians (mrad). The latter corresponds to a native instantaneous FOV of 68 m. for a satellite altitude of 400 km.

The sensor 100a may also include a filter 113a and a camera controller 115a. In some embodiments, the filter 113a may be a spectral bandpass filter and/or a polarization filter, and it may be placed on one of the optical surfaces between the camera 111a and the lens 112a. A mechanical support 116a is designed to have low weight and low vibration, for example by introducing a large damping factor for mechanical vibrations falling within a specified frequency range. Video card 117a temporarily stores image data from the camera 11a and motion data provided by an inertial measurement unit (IMU) 118, for transmission in real-time or near real-time to a signal processor that is in communication with the tracking station 40. An IMU typically incorporates angle rate sensors and/or three accelerometers that measure the instantaneous acceleration along 3 orthogonal axes.

FIG. 2B shows an exemplary second embodiment of a small-satellite sensor 100b, which is suitable for a satellite with a 3U form factor, having a usable enclosed volume of, for example, 10×20×30 cm. To cover the LWIR band from 8 to 12 microns, a filter wheel 113b is equipped with, for example, six bandpass filters which are successively rotated into position in front of the thermal camera. Each filter has a wavelength passband width of about 0.5 microns. The filter wheel 113b is controlled automatically by a wheel controller 114b in order to generate a sequence of images covering the LWIR spectral range. Mechanical support 116b is much larger in size and weight than mechanical support 116a due to the extra volume taken up by the filter wheel and its controller. Sensor 100b typically also includes a video card 117b, and an IMU (not shown) which are similar to the corresponding elements in sensor 100a.

FIG. 3 shows a block diagram of an exemplary method 200 for forming an HS image cube with high spatial resolution, according to the invention. The method 200 includes the following steps:
Step 220: Receiving image frame sequences from a flock of sensors;
Step 230: Calibrating the image frame sequences;
Step 240: Registering the image frame sequences; and
Step 250: Applying one or more image enhancement algorithms to form an HS image cube with high spatial resolution.

The steps in method 200 generally are implemented in signal processor 50 which may be physically located in one of the sensors belonging to flock 20. This is only feasible if the power, size and weight requirements of the signal processor can be satisfied within the confines of a small sensor. In some embodiments, it is advantageous to place the signal processor inside, or proximal to, for example, a tracking station where the power, size and weight limitations are likely to be less restrictive than those of a small sensor.

Step 230 includes calibration algorithms such as corrections for white balance, variations in illumination, optical aberrations, motion compensation, projective and coordinate transformations and the like, all of which are well-known to those skilled in the art of photogrammetry. However, there are several additional calibrations which are specific to uncooled LWIR sensors, because of their sensitivity to changes in FPA and environmental temperatures. To be sure, the temperature sensitivity may be reduced through the use of a copper thermal shield, such as that described in a paper by B. D. Oelrich et al., entitled “Radiometric packaging of uncooled microbolometer FPA arrays for space applications”, which appeared in Proceedings of SPIE vol. 7206, no. 720604, February 2009. Nonetheless, it is still necessary in general to correct the gain and offset of the LWIR sensor by a calibration formula such as that appearing in equation (1) of a paper by I. Klapp et al., entitled “Using Computational Optics for Agricultural Monitoring with an Emphasis on Irrigation Management Zones”, published in Precision Agriculture '19 Conference Proceedings, July 2019, pp. 665-671.

Step 240 includes registration algorithms, such as time alignment of an image frame sequence generated by a single satellite sensor and spatial alignment of images acquired by the sensors of different small satellites. Time alignment involves the estimation of a homography transformation, which relates images undergoing a rotation about a camera centre. Assuming a planar region-of-interest (ROI), simplified algorithms are available such as Simultaneous Localization and Mapping (SLAM) or ORB-SLAM which also includes feature detection. The SLAM and ORB-SLAM algorithms are known to those skilled in the art of remote sensing.

Spatial alignment involves estimating a projective transformation relating image frames acquired by different sensors. The estimation may be assisted by inputting orbit data 45. The orbit data may include data supplied by navigational aids, e.g. accelerometers, and/or data supplied by the tracking station 40. Generally, the accuracy of spatial alignment deteriorates as the distance between the sensors in the flock increases.

Step 250 involves the use of one or more image enhancement algorithms. The latter include, for example, image data fusion and/or super-resolution algorithms for resolution enhancement.

Image data fusion consists of fusing the image data from the flock of sensors, together with optional data from other sensors, such as the open satellites listed in Table 1, to form the HS image cube 60 with high spatial resolution. For example, the images provided by the VIS detector in sensor A have higher resolution and SNR than those provided by the NIR detector in sensor B, and much greater resolution and SNR than those provided by the LWIR detector in sensor C. For this reason, it is advantageous to generate the HS image cube 60 with high spatial resolution by incorporating the information from both high-resolution VIS and low-resolution infrared images of the overlapped ROI.

Super-resolution algorithms for resolution enhancement involve combining images of an overlapped ROI acquired by sensors having different point-spread functions (PSFs), different pixel sizes, different SNRs, and different integration and/or frame times. The abovementioned reference WO'863 gives additional information regarding the super-resolution algorithms.

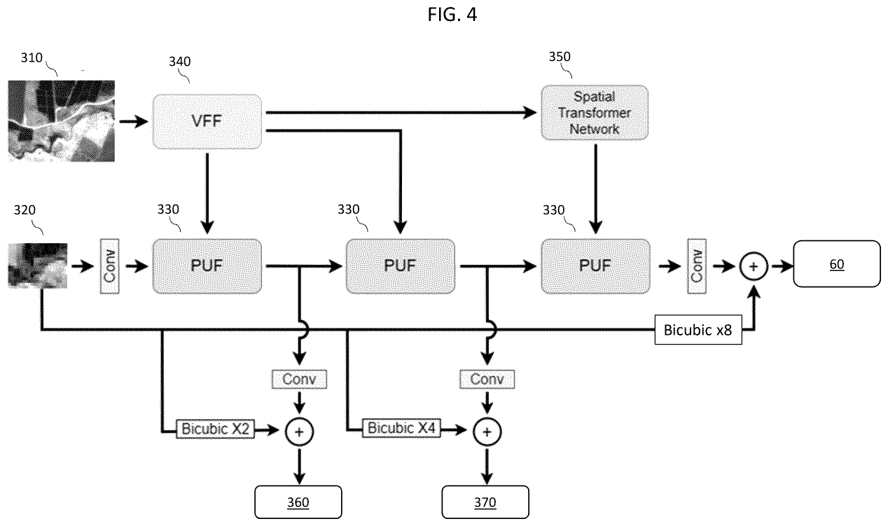

FIG. 4 shows a block diagram of an exemplary neural network (NN) for implementing the method of the invention. The NN receives as input both a VIS image 310 and a low-resolution infrared image 320. VIS image 310 is processed by Visible Feature Framer (VFF) module 340. The output of module 340 is input to a Spatial Transformer Network (STN) module 350. Infrared image 320 undergoes convolution (or “Conv”) and the image resolution is increased successively by three Process-Upscale-and-Fuse (PUF) modules 330. Intermediate infrared images 360 and 370 are generated using Bicubic X2 and Bicubic X4 interpolation, respectively. The third PUV (from the left) operates on input from the STN module 350. Output from the third PUF undergoes convolution and is then combined at the plus (“+”) symbol with a Bicubic X8 interpolation of the infrared image, in order to form the HS image cube 60 with high spatial resolution.

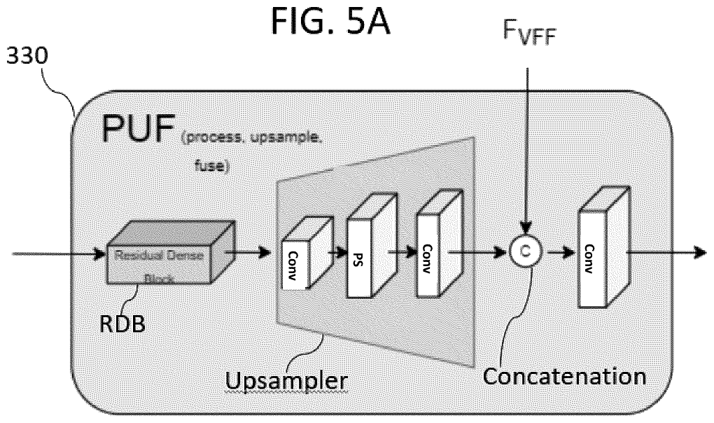

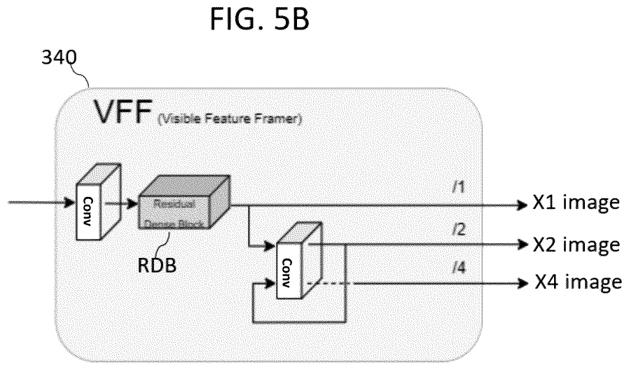

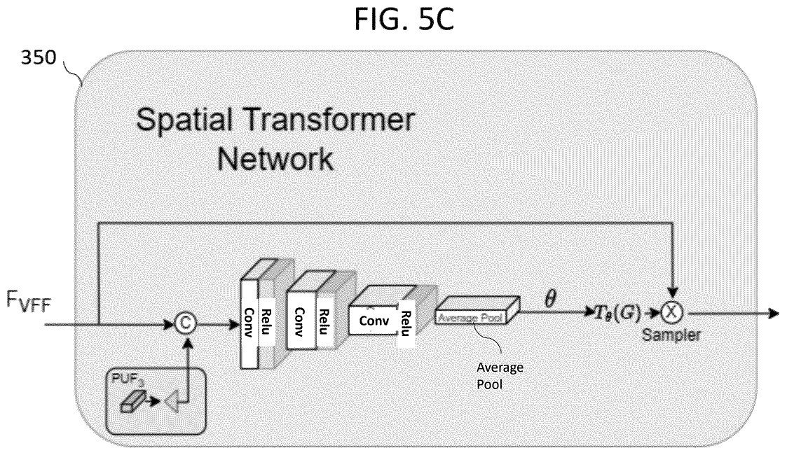

FIGS. 5A, 5B, and 5C show block diagrams for each of the three modules in the neural network of FIG. 4, namely: PUF module 330, VFF module 340, and STN module 350, respectively. Each PUF produces an output image whose resolution is twice that of the input image. In FIG. 5A, the PUF module 330 includes a Residual Dense Block (RDB) followed by an Upsampler and a Concatenation (“C”). The RDB uses a single convolution layer with a kernel of size 1 in order to fuse layers within the block. The Upsampler utilizes a PixelShuffle (PS) operation to efficiently implement sub-pixel convolutions. PixelShuffle is an algorithm which is familiar to those skilled in the art of image processing. The Concatenation incorporates the output of the Upsampler with a feature map FvF provided by the VFF module 340.

FIG. 5B shows the functions performed in the VFF module 340. This module uses convolution (“Conv”) and an RDB to produce images with X1, X2, and X4 resolutions.

FIG. 5C shows the functions performed in the STN module 350. The latter acts on the feature map F_{VFF} to correct for misalignments between the VIS image 310 and the low-resolution infrared image 320. The STN applies 3 successive functions each consisting of a convolution followed by a Rectified Linear Unit (Relu). The latter, which is an activation function that introduces nonlinearity, is familiar to those skilled in the art of deep learning. In FIG. 5C, the symbol θ represents a vector of parameters characterizing an affine transformation, and T_{θ}(G) is an operator which applies the transformation to a grid (or array) G.

### Example 1

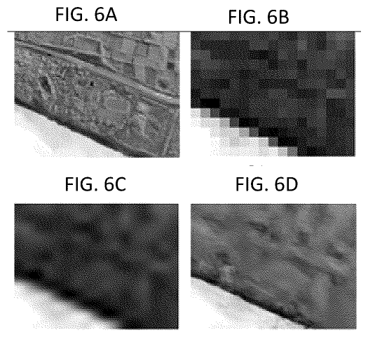

FIGS. 6A-6D show results of various HS imaging algorithms applied to a first set of experimentally recorded images. FIG. 6A shows a “ground truth” image, and FIG. 6B is a computer simulation of a corresponding panchromatic image that would be acquired by a small satellite at an altitude of 400 km. FIG. 6C is obtained by a bi-cubic interpolation algorithm applied to FIG. 6B. Finally, FIG. 6D is the result of applying a super-resolution algorithm to form a panchromatic HS image cube. Comparing FIGS. 6C and 6D, one notes that, where image contrast is high, the HS image cube in FIG. 6D provides greater detail than the image in FIG. 6C.

### Example 2

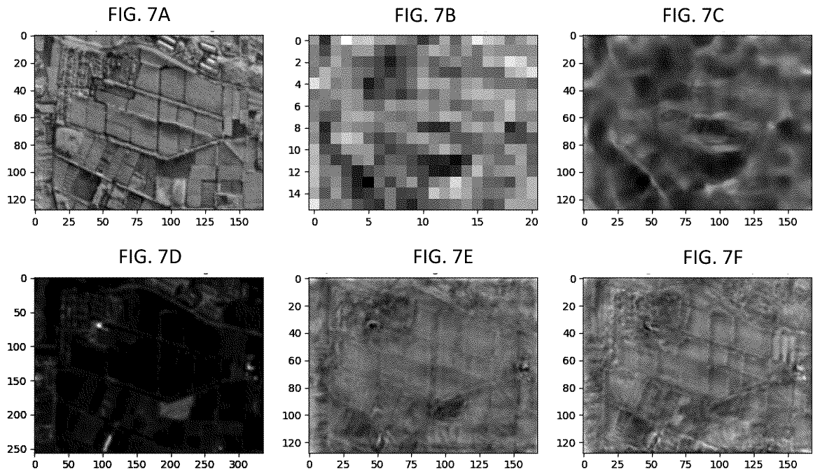

FIGS. 7A-7F show results of various HS imaging algorithms applied to a second set of experimentally recorded images. FIG. 7A is a down-sampled version of a high resolution aerial image, recorded by an airborne forward-looking infrared (FLIR) Tau2 panchromatic thermal camera. The altitude of the airborne camera is two km. above the Earth's surface, and the camera lens has a focal length of 9.8 mm. The geometrical magnification prior to down-sampling is (9.8 mm)/(2 km)=4.9 mm/km. After down-sampling by a factor of 2, the magnification is decreased to M_{A}=4.9/2=2.45 mm/km. This results in the “ground truth” high-resolution panchromatic image of FIG. 4A, which provides a benchmark for other images formed by a variety of image processing algorithms utilizing IR and/or red-green-blue (RGB) spectral bands.

FIG. 7B is a low-resolution panchromatic image, for the same area as that shown in FIG. 4A. FIG. 5B simulates a satellite image that would be obtained at an altitude of 400 km., using the FLIR panchromatic thermal camera of FIG. 5A, but with a camera lens having a focal length of approximately 123 mm. The simulated image has a geometrical magnification of M_{B}=(123 mm)/(400 km)=0.31 mm/km.

FIG. 7C represents an image obtained by applying 8×super-resolution to the IR band of the simulated satellite image in FIG. 7B. The enhanced resolution corresponds to a geometrical magnification of M_{C}=8M_{B}=2.46 mm/km, which is nearly equal to M_{A}. Thus, the resolution in FIG. 7C is comparable to that of the “ground truth” panchromatic image in FIG. 7A.

FIG. 7D is an RGB image, for the same area as that shown in FIG. 7A. By way of example, the image in FIG. 7D may be provided by the VIS band of sensor A, in the flock of three sensors shown in the block diagram of FIG. 2. (The image in 7D is similar to images provided by the RGB band of the Copernicus Sentinel mission.)

FIG. 7E represents an 8X super-resolution image obtained by combining the IR image of FIG. 7B together with the RGB image of FIG. 7D, using image registration, followed by a double input 8X super-resolution algorithm and the application of an L1-norm (e.g. absolute value) as a cost function. Finally, FIG. 7F is the result of combining FIGS. 7B and 7D, using the same algorithms as in FIG. 7E, but with the addition of a perceptual loss (or cost) function to the L1-norm. The use of such loss functions is well known to those skilled in the art of image processing with neural networks.

### Example 3

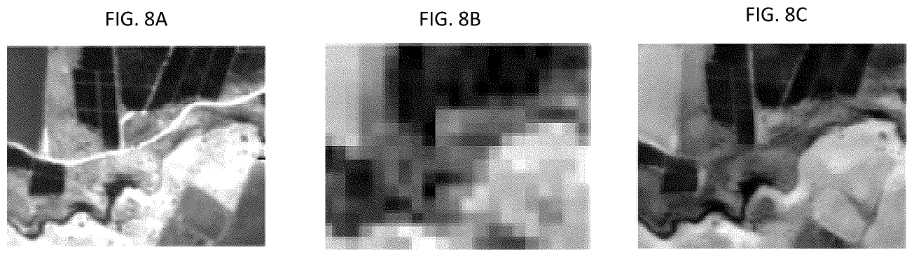

FIGS. 8A-8C show the results of various HS imaging algorithms applied to a third set of experimentally recorded images. FIG. 8A shows an aerial high-resolution VIS image of an ROI. FIG. 8B shows a low-resolution infrared image of the same region. Finally, FIG. 8C shows a HS image cube with high spatial resolution obtained from the images in FIGS. 8A and 8B by applying the method of the invention using the exemplary neural network of FIG. 4. Note that the spatial resolution of the HS image cube of FIG. 8C is comparable to that of the high-resolution VIS image in FIG. 8A.

The descriptions of the various embodiments of the present disclosure have been presented for purposes of illustration but are not intended to be exhaustive or limited to the embodiments disclosed. For example, with regard to the wavelength bands covered by the sensors, a given sensor may cover either a single wavelength band or a multiplicity of bands, depending upon the physical limitations imposed by the form factor of the sensor. Specifically, the imaging device in one or more of the satellites could be a monochromatic camera, an RGB color camera, and/or a panchromatic camera.

Furthermore, the method of the invention, as illustrated in the block diagram of FIG. 3 and the exemplary block diagrams of a neural network in FIGS. 4, 5A, 5B, and 5C, may be extended to more general assemblies of sensors wherein the sensors use different modalities that are not limited to those used by satellites. For example, the flock of sensors may include airborne, ground-based, marine, sub-marine, or even capsule endoscopy sensors. Furthermore, the imaging devices of the sensors need not be optical; for example, they may be ultrasonic, radar, or lidar imaging devices.

Many other modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for hyperspectral imaging comprising:
a flock of at least two sensors configured to provide image frame sequences in at least two different spectral bands;
a signal processor configured for receiving, correcting and analyzing said image frame sequences to form a hyperspectral (HS) image cube with high spatial resolution; and
an output device for recording and/or displaying said HS image cube;
wherein the at least two sensors pass above an overlapped region-of-interest.

2. The system of claim 1 wherein at least one of the sensors comprises an imaging device selected from a group consisting of a monochromatic camera, a color camera, a thermal camera, an infrared camera, a panchromatic camera and a bolometer focal plane array.

3. The system of claim 1 wherein at least one of the sensors comprises a camera controller, a mechanical support, a spectral bandpass filter, a video card, an accelerometer, and/or an inertial measurement unit.

4. The system of claim 1 wherein the different spectral bands comprise a band selected from a group consisting of a visual band, a near-infrared band, a short-wave infrared band, and a long-wave infrared band.

5. The system of claim 1 wherein at least two of the sensors are characterized by different pixel sizes, spatial resolutions, polarizations, integration times, frame times, signal-to-noise ratios, and/or point spread functions.

6. The system of claim 1 wherein correcting and analyzing said image frame sequences comprises a calibration algorithm further comprising correction of white balance, gain, offset, illumination, and/or optical aberrations.

7. The system of claim 1 wherein correcting and analyzing said image frame sequences comprises a registration algorithm further comprising temporal alignment, spatial alignment, projective transformation estimation, feature detection, and/or simultaneous localization and mapping.

8. The system of claim 1 wherein correcting and analyzing said image frame sequences comprises a super-resolution algorithm further comprising an absolute value cost function, a perceptual loss function, and/or a sum of cost and loss functions.

9. The system of claim 1 wherein the signal processor is communication with or integrated with a tracking station.

10. The system of claim 1 wherein at least two of the sensors are mounted on different platforms.

11. The system of claim 10 wherein at least one of the platforms is a small satellite having a mass in a range of 1 to 10 kilograms.

12. A method for hyperspectral imaging, the method comprising the steps:
a) receiving data from a flock of at least two sensors configured to provide image frame sequences in at least two different spectral bands;
b) applying a calibration algorithm to the image frame sequences;
c) applying a registration algorithm to the image frame sequences; and
d) applying one or more image enhancement algorithms to form a hyperspectral (HS) image cube with high spatial resolution;
wherein the at least two sensors form images of an overlapped region-of-interest.

13. The method of claim 12 comprising an additional step e) which comprises storing and/or displaying the HS image cube in an output device.

14. The method of claim 12 wherein the at least two different spectral bands comprise at least one visual band and one or more infrared bands.

15. The method of claim 12 wherein the calibration algorithm comprises correction of white balance, gain, offset, illumination, and/or optical aberrations.

16. The method of claim 12 wherein the registration algorithm comprises temporal alignment, spatial alignment, projective transformation estimation, feature detection, and/or simultaneous localization and mapping.

17. The method of claim 12 wherein the one or more image enhancement algorithms comprise an image data fusion algorithm and/or a super-resolution algorithm.

18. The method of claim 17 wherein the super-resolution algorithm comprises an absolute value cost function, a perceptual loss function, and/or a sum of cost and loss functions.

19. The method of claim 12 wherein the method is implemented by a neural network.

20. The method of claim 19 wherein the neural network receives as input a high-resolution visual image and a low-resolution infrared image.

21. The method of claim 19 wherein the neural network comprises at least one module selected from a group consisting of a Visible Feature Framer (VFF) module, a Spatial Transformer Network (STN) module, and a Process-Upscale-and-Fuse (PUF) module.

22. A computer usable non-transitory storage medium having a computer program thereon for causing a suitably programmed signal processor to process images, by performing the steps of claim 12 when such program is executed on the signal processor.
